(19) United States
(12) Patent Application Publication
(10) Pub. No.: US 2006/0106801 A1
(43) Pub. Date: May 18, 2006

(54) Securing location of an installed middleware application and securing location of containers contained within installed middleware application

(75) Inventors: David E. Cox, Raleigh, NC (US); Craig M. Lawton, Raleigh, NC (US); Jonathan A. Lewis, Morrisville, NC (US); Christopher A. Peters, Round Rock, TX (US); Lorin E. Ullmann, Austin, TX (US); Douglas A. Wood, Raleigh, NC (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 10/988,473

(22) Filed: Nov. 12, 2004

(51) Int. Cl. G06F 17/30; G06F 7/00

(52) U.S. Cl. 707/9; 707/1

(57) ABSTRACT

A method, computer program product and system for protecting the location of an installed middleware application. An installer program may generate a private/public key pair at build time of a middleware application. Upon the installer program installing the middleware application, the installation location of the middleware application may be encrypted using the generated private key and then discarding the private key. The encrypted installation location of the middleware application may be decrypted by a subsequent installer program upon receiving a public key from the developer of the middleware application. Since the public key was not shipped with the middleware application, an illegitimate program, such as a Trojan horse, may not be able to decrypt the installation location of the middleware application. Since the public key may only be obtained from the developer of the middleware application, only legitimate programs may be able to decrypt the location of the installed middleware application.

### TECHNICAL FIELD

The present invention relates to the field of installation programs, and more particularly to securing the location of an installed middle application, as well as the location of the containers contained within the installed middleware application.

### BACKGROUND INFORMATION

An installer program enables a programmer to write specific code to install a given software program onto the drives of a computer in a way that enables the given software program to work correctly with the computer's environment, including its operating system. There are several types of installer programs, such as Java installers and operating system specific installers, e.g., Microsoft Windows installers, International Business Machine's (“IBM's”) OS/2 and AIX operating system installers.

Installer programs may also install middleware applications (e.g., an application server or a relational database management system) onto the computer system. (An application server may refer to software in an Intranet/Internet environment that hosts a variety of language systems used to program database queries and/or general business processing.) These installed middleware applications may store what is referred to as “containers.” A container may refer to software that acts as a parent program to hold and execute a set of commands or to run other software routines. For example, in environments with an application server, a container may contain Java Server Pages (JSPs), Enterprise JavaBeans (EJBs) or JavaBeans.

As a result of business transactions performed over the Internet, many types of information may be stored in the container including personal information, such as credit card information, address, phone number, etc. Often this information is simply protected by a user identification and password provided at the operating system level. Typically, there is no security protection for the installed middleware application or the container within the installed middleware application. Consequently, the location of the installed middleware application may be easily obtained.

The ease of obtaining the location of the installed middleware application may allow illegitimate programs, such as a Trojan horse, to perform illicit activities when they are run. For example, if a Trojan horse were able to obtain the location of an installed middleware application, such as an application server, then the Trojan horse may indicate that the location of the installed application server is the location of the Trojan horse. Consequently, legitimate information, e.g., credit card information, to be installed in the container within the legitimate application server may be unintentionally installed within the Trojan horse. Hence, there is a need to protect the location of the installed middleware application as well as to protect the location of containers within the installed middleware application.

While there is a need to protect the location of the installed middleware application, as well as a need to protect the location of containers within the installed middleware application, there is also a need to allow such locations to be available to legitimate programs. Legitimate programs may need to know such locations in order to install appropriate applications at appropriate locations.

Therefore, there is a need in the art to secure the location of the installed middleware application as well as to protect the location of containers within the installed middleware application while providing these locations to legitimate programs.

### SUMMARY

The problems outlined above may at least in part be solved in some embodiments by an installer program encrypting the installation location of the middleware application, e.g., application server, with a private key generated at build time and then discarding the private key. The encrypted installation location of the middleware application may be decrypted by a subsequent installer program upon receiving a public key from the developer of the middleware application. Since the public key was not shipped with the middleware application, an illegitimate program, such as a Trojan horse, may not be able to decrypt the installation location of the middleware application. Since the public key may only be obtained from the developer of the middleware application, only legitimate programs may be able to decrypt the location of the installed middleware application.

Further, the location of containers within installed middleware applications may be protected by an installer program encrypting the contents of a registry which contains the installation locations of containers using a symmetric key generated at build time of the middleware application. The symmetric key may be stored in a password file that may be located only using an appropriate algorithm. Upon a subsequent installer program obtaining the symmetric key using the appropriate algorithm, the contents of the registry may be decrypted and hence the installation locations of containers may be found. By storing the symmetric key in a password file that may only be located using an appropriate algorithm, illegitimate programs, such as Trojan horse, may not be able to obtain the symmetric key and hence may not be able to decrypt the installation locations of the containers. Since the symmetric key may only be obtained using an appropriate algorithm, only legitimate programs may be able to decrypt the installation locations of the containers.

In one embodiment of the present invention, a method for protecting the location of an installed middleware application may comprise the steps of generating a private/public key pair at build time of a middleware application, installing the middleware application, storing an installation location of the middleware application in a registry, encrypting the installation location of the middleware application with the generated private key and discarding the generated private key.

In another embodiment of the present invention, a method for protecting the location of containers contained within an installed middleware application may comprise the steps of generating a symmetric key at build time of a middleware application, installing a container, installing a middleware application to store the installed container, encrypting an installation location of the container with the generated symmetric key and storing the generated symmetric key in a password file.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of an application server and a registry;

FIG. 3 is a flowchart of a method for protecting the location of an installed middleware application in accordance with an embodiment of the present invention; and

FIG. 4 is a flowchart of a method for protecting locations of containers contained within an installed middleware application in accordance with an embodiment of the present invention.

### DETAILED DESCRIPTION

The present invention comprises a method, computer program product and system for protecting the location of an installed middleware application. In one embodiment of the present invention, a private/public key pair may be generated at build time of a middleware application. Upon installing the middleware application, the installation location of the middleware application may be encrypted using the generated private key and then discarding the private key. The encrypted installation location of the middleware application may be decrypted by a subsequent installer program upon receiving a public key from the developer of the middleware application. Since the public key was not shipped with the middleware application, an illegitimate program, such as a Trojan horse, may not be able to decrypt the installation location of the middleware application. Since the public key may only be obtained from the developer of the middleware application, only legitimate programs may be able to decrypt the location of the installed middleware application.

Although the present invention is described with reference to protecting the installation location of middleware applications, such as application servers, and the installation locations of containers contained therein, it is noted that the principles of the present invention may be applied to protecting the installation location of any type of software application as well as protecting the installation locations of containers contained therein. It is further noted that embodiments applying the principles of the present invention to protecting the installation locations of software applications and the installation locations of containers contained therein would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

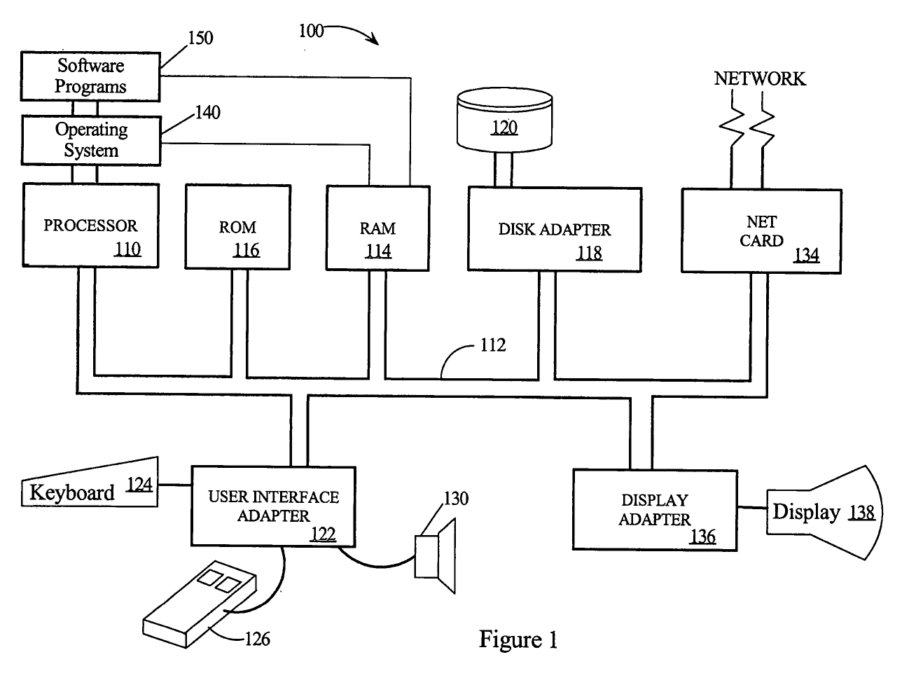

FIG. 1—Computer System

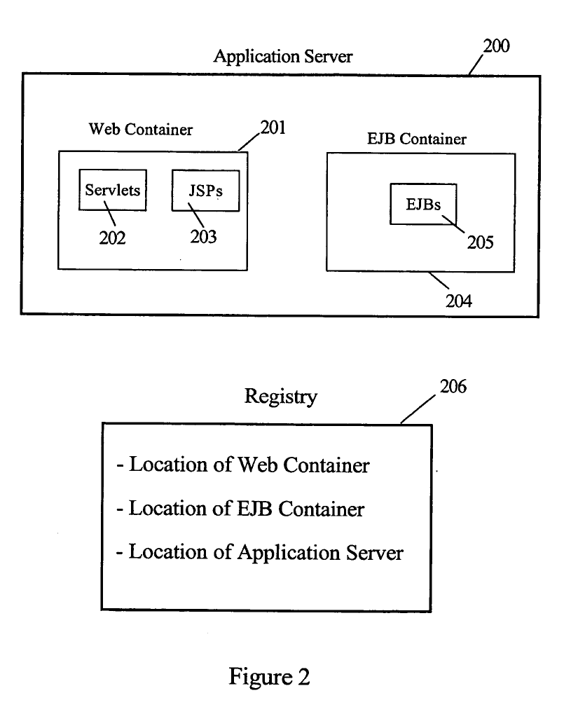

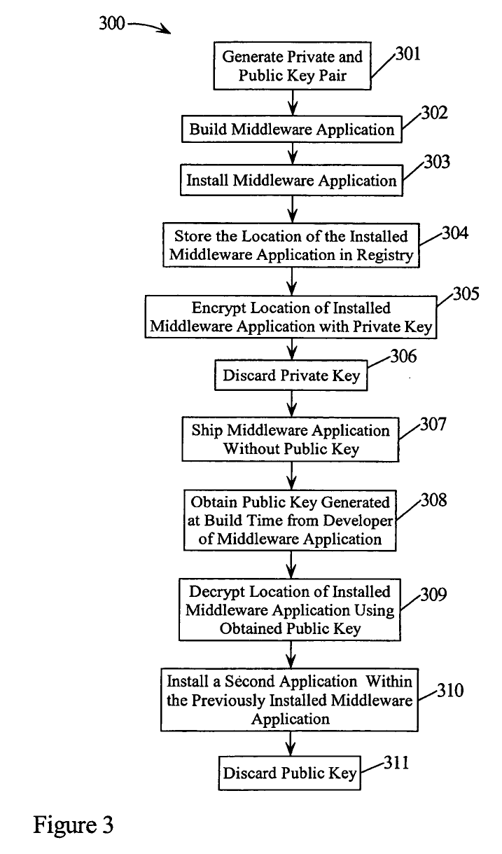

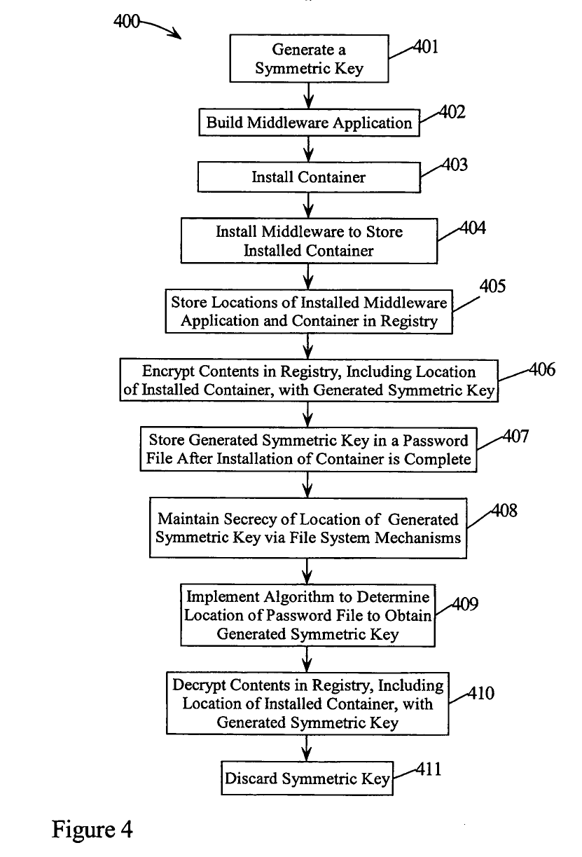

FIG. 1 illustrates a typical hardware configuration of computer system 100 which is representative of a hardware environment for practicing the present invention. Computer system 100 may have a processor 110 coupled to various other components by system bus 112. An operating system 140 may run on processor 110 and provide control and coordinate the functions of the various components of FIG. 1. Software program(s) 150 in accordance with the principles of the present invention may run in conjunction with operating system 140 and provide calls to operating system 140 where the calls implement the various functions or services to be performed by software program(s) 150. Software program(s) 150 may include, for example, an installer program, e.g., Platform Installation and Configuration Service (PICS), configured to protect and retrieve the location of an installed middleware application, such as an application server, by encrypting the installation location with a private key as discussed further below in association with FIG. 3. FIG. 3 is a flowchart of a method for protecting and retrieving the location of an installed middleware application. Software program(s) 150 may also include a registry and the application server referred to above. A more detail description of the application server and the registry is provided below in association with FIG. 2. Software program(s) 150 may also include an installer program configured to protect and retrieve the installation location of containers contained within an installed middleware application as discussed further below in association with FIG. 4. FIG. 4 is a flowchart of a method for protecting and retrieving the installation location of containers contained within an installed middleware application.

Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software components including operating system 140 and software program(s) 150 may be loaded into RAM 114 which may be computer system's 100 main memory for execution. Disk adapter 118 may be an integrated drive electronics (“IDE”) adapter that communicates with a disk unit 120, e.g., disk drive. It is noted that the installer programs, application server and registry mentioned above, may reside in disk unit 120 or in software program(s) 150. It is further noted that disk unit 120 may also store a password file used to store encrypted passwords as discussed further below in association with FIG. 4.

Referring to FIG. 1, computer system 100 may further comprise a network card 134 coupled to bus 112. Network card 134 may interconnect bus 112 with an outside network, e.g., Local Area Network (LAN), Wide Area Network (WAN), enabling computer system 100 to communicate with other such systems. I/O devices may also be connected to system bus 112 via a user interface adapter 122 and a display adapter 136. Keyboard 124, mouse 126 and speaker 130 may all be interconnected to bus 112 through user interface adapter 122. Data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138 or speaker 130.

Implementations of the invention include implementations as a computer system programmed to execute the method or methods described herein, and as a computer program product. According to the computer system implementations, sets of instructions for executing the method or methods may be resident in the random access memory 114 of one or more computer systems configured generally as described above. Until required by computer system 100, the set of instructions may be stored as a computer program product in another computer memory, for example, in disk unit 120. Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 2—Application Server and Registry

FIG. 2 illustrates an embodiment of the present invention of an application server 200. Application server 200 may refer to software in an Intranet/Internet environment that hosts a variety of language systems used to program database queries and/or general business processing. Application server 200 may store one or more “containers”. Containers may refer to software that act as a parent program to hold and execute a set of commands. For example, application server 200 may store a container, referred to herein as a “web container” 201, used to store software components such as servlets 202 and JavaServer Pages (JSPs) 203. Application server 200 may also store a container, referred to herein as an “Enterprise JavaBean (EJB) container” 204, used to store EJBs 205. It is noted that FIG. 2 is illustrative and that application server 200 may store any number of containers storing any number of software components.

FIG. 2 further illustrates an embodiment of the present invention of a registry 206. Registry 206 may refer to a database used for storing the location of application server 200 as well as the location of containers, e.g., containers 201, 204, within application server 200. A more detailed discussion of using registry 206 in connection with protecting the location of an installed middleware application is provided further below in association with FIG. 3.

As stated in the Background Information section, the ease of obtaining the location of the installed middleware application may allow illegitimate programs, such as a Trojan horse, to perform illicit activities when they are run. For example, if a Trojan horse were able to obtain the location of an installed middleware application, such as an application server, then the Trojan horse may indicate that the location of the installed application server is the location of the Trojan horse. Consequently, legitimate information, e.g., credit card information, to be installed in the container within the legitimate application server may be unintentionally installed within the Trojan horse. Hence, there is a need to protect the location of the installed middleware application as well as a need to protect the location of containers within the installed middleware application. While there is a need to protect the location of the installed middleware application, e.g., application server, as well as to protect the location of containers within the installed middleware application, there is also a need to allow such locations to be available to legitimate programs. Legitimate programs may need to know such locations in order to install appropriate applications at appropriate locations. Therefore, there is a need in the art to secure the location of the installed middleware application as well as to protect the location of containers within the installed middleware application while providing these locations to legitimate programs.

The location of an installed middleware application, such as application server 200, may be protected while providing this location to legitimate programs by using the method as described below in association with FIG. 3. The locations of containers, such as containers 201 and 204, within a middleware application, such as application server 200, may be protected while providing these locations to legitimate programs by using the method as described further below in association with FIG. 4.

FIG. 3—Method for Protecting and Retrieving the Location of an Installed Middleware Application

FIG. 3 is a flowchart of one embodiment of the present invention of a method 300 for protecting the location of an installed middleware application, e.g., application server 200 (FIG. 2).

Referring to FIG. 3 in conjunction with FIGS. 1-2, in step 301, an installer program generates a private/public key pair. A private/public key pair may be used to encrypt and decrypt messages using asymmetric cryptography. Asymmetric cryptography is well known in the art and will not be discussed in detail for the sake of brevity.

In step 302, a middleware application, such as application server 200, is built. Built refers to the time when the middleware application is compiled into executable form.

In step 303, the installer program installs the middleware application, such as application server 200, on system 100. In step 304, the installer program stores the location of the installed middleware application, such as application server 200, in registry 206 as illustrated in FIG. 2. Referring to FIG. 2, registry 206 contains the installed location of application server 200.

Returning to FIG. 3, in step 305, the installer program encrypts the location of the installed middleware application with the private key generated at build time. The location of the installed middleware application is encrypted with the private key so that an illegitimate program, such as a Trojan horse, may not be able to determine the location of the installed middleware application.

In step 306, the installer program discards the private key.

In step 307, the installed middleware application (e.g., within system 100) is shipped without the public key. By not shipping the public key with the middleware application, an illegitimate program, such as a Trojan horse, may not be able to decrypt the location of the installed middleware application and hence not be able to obtain the location of the installed middleware application. By not being able to obtain the location of the installed middleware application, the illegal program may be prevented from performing illegal activities such as indicating a false location for the installed middleware application.

In step 308, a subsequent installer program (a legitimate application) that plans on installing another application within the previously installed middleware application, e.g., install an application in a container within application server 200 installed in step 303, obtains the public key from the developer of the middleware application. In step 309, the subsequent installer program decrypts the location of the installed middleware application, such as application server 200, on system 100 using the obtained public key.

In step 310, the subsequent installer program installs the new application within the previously installed middleware application, e.g., application server 200. In step 311, the subsequent installer program discards the public key.

It is noted that method 300 may include other and/or additional steps that, for clarity, are not depicted. It is further noted that method 300 may be executed in a different order presented and that the order presented in the discussion of FIG. 3 is illustrative. It is further noted that certain steps in method 300 may be executed in a substantially simultaneous manner.

The locations of containers, such as containers 201 and 204, within the installed middleware application, such as application server 200, may be protected while providing these locations to legitimate programs by using the method as described below in association with FIG. 4.

FIG. 4—Method for Protecting and Retrieving the Locations of Containers Contained Within an Installed Middleware Application

FIG. 4 is a flowchart of one embodiment of the present invention of a method 400 for protecting the locations of containers, e.g., container 201 (FIG. 2), container 204 (FIG. 2), within an installed middleware application, e.g., application server 200 (FIG. 2).

Referring to FIG. 4 in conjunction with FIGS. 1-3, in step 401, an installer program generates a symmetric key. A symmetric key may be used to encrypt and decrypt messages using symmetric cryptography. Symmetric cryptography is well known in the art and will not be discussed in detail for the sake of brevity.

In step 402, a middleware application, such as application server 200, is built. Built refers to the time when the middleware application is compiled into executable form.

In step 403, the installer program installs a container, e.g., container 201, on system 100. In step 404, the installer program installs a middleware application, e.g., application server 200, on system 100 to store the installed container, e.g., container 201.

In step 405, the locations of the installed server 200 and container 201 are stored in registry 206. Referring to FIG. 2, registry contains the location of the installed middleware application, such as application server 200, as well as the location of installed containers, such as containers 201, 204, which are stored in application server 200.

In step 406, the installer program encrypts the contents of registry 206 which includes the locations of containers, such as containers 201, 204, which were installed in a middleware application, such as application server 200, with the symmetric key generated in step 401. In one embodiment, the contents of registry 206 may be additionally protected by requiring appropriate authorization, e.g., appropriate user name and password, in order to access registry 206.

In step 407, the installer program stores the generated symmetric key in a password file after the installation of the container is complete. A password file may refer to a database that stores encrypted passwords which are typically not displayed to a user. In one embodiment, the password file may be located on disk unit 120. In step 408, the location of the symmetric key (location of the password file) is maintained secret via file system mechanisms.

In step 409, a subsequent installer program obtains the location for the generated symmetric key in the password file using an appropriate hard-coded algorithm available only to legitimate installer programs. In an alternative embodiment, a subsequent installer program (a legitimate program) may instead directly obtain the symmetric key from the developer of the middleware application. In this embodiment, the symmetric key may be discarded instead of being stored in a password file in step 407 as discussed above. Since the location of the symmetric key may only be obtained either from the developer of the middleware application or by using an appropriate algorithm available to legitimate installer programs, illegitimate programs, such as a Trojan horse, may not be able to obtain the symmetric key in the password file and hence decrypt the contents of registry 206. By not being able to decrypt the contents of registry 206, an illegal program may be prevented from accessing the contents of registry 206 and hence obtain the installed locations of containers, e.g., container 201, within a middleware application, e.g., application server 200.

In step 410, the subsequent installer program decrypts the contents of registry 206 using the obtained symmetric key thereby accessing the installed locations of containers, e.g., container 201, stored within an installed middleware application, such as application server 200. In step 411, the subsequent installer program discards the obtained symmetric key.

It is noted that method 400 may include other and/or additional steps that, for clarity, are not depicted. It is further noted that method 400 may be executed in a different order presented and that the order presented in the discussion of FIG. 4 is illustrative. It is further noted that certain steps in method 400 may be executed in a substantially simultaneous manner.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for protecting the location of an installed middleware application, comprising the steps of:
generating a private/public key pair at build time of a first middleware application;
installing said first middleware application;
storing an installation location of said first middleware application in a registry;
encrypting said installation location of said first middleware application with said generated private key; and
discarding said generated private key.

2. The method as recited in claim 1, further comprising the steps of:
obtaining said generated public key; and
decrypting said installation location of said first middleware application with said obtained public key.

3. The method as recited in claim 2, wherein said generated public key is obtained from a developer of said middleware application.

4. The method as recited in claim 2, further comprising the steps of:
installing a second application within said first middleware application; and
discarding said generated public key.

5. A method for protecting the location of containers contained within an installed middleware application comprising the steps of:
generating a symmetric key at build time of a middleware application;
installing a container;
installing said middleware application to store said installed container;
encrypting an installation location of said container with said generated symmetric key; and
storing said generated symmetric key in a password file.

6. The method as recited in claim 5, further comprising the steps of:
implementing an algorithm to determine a location of said password file to obtain said generated symmetric key; and
decrypting said installation location of said container with said obtained symmetric key.

7. The method as recited in claim 6, further comprising the step of:
discarding said obtained symmetric key.

8. A computer program product embodied in a machine readable medium for protecting the location of an installed middleware application, comprising the programming steps of:
generating a private/public key pair at build time of a first middleware application;
installing said first middleware application;
storing an installation location of said first middleware application in a registry;
encrypting said installation location of said first middleware application with said generated private key; and
discarding said generated private key.

9. The computer program product as recited in claim 8, further comprising the programming steps of:
decrypting said installation location of said first middleware application with said generated public key obtained from a developer of said first middleware application.

10. The computer program product as recited in claim 9, further comprising the programming steps of:
installing a second application within said first middleware application; and
discarding said generated public key.

11. A computer program product embodied in a machine readable medium for protecting the location of containers contained within an installed middleware application, comprising the programming steps of:
generating a symmetric key at build time of a middleware application;
installing a container;
installing said middleware application to store said installed container;
encrypting an installation location of said container with said generated symmetric key; and
storing said generated symmetric key in a password file.

12. The computer program product as recited in claim 11, further comprising the programming steps of:
implementing an algorithm to determine a location of said password file to obtain said generated symmetric key; and
decrypting said installation location of said container with said obtained symmetric key.

13. The computer program product as recited in claim 12, further comprising the programming step of:
discarding said obtained symmetric key.

14. A system, comprising:
a processor; and
a memory unit coupled to said processor, wherein said memory unit is operable for storing a first computer program for protecting the location of an installed middleware application;
wherein said processor, responsive to said first computer program, comprises:
circuitry for generating a private/public key pair at build time of a first middleware application;
circuitry for installing said first middleware application;
circuitry for storing an installation location of said first middleware application in a registry;
circuitry for encrypting said installation location of said first middleware application with said generated private key; and
circuitry for discarding said generated private key.

15. The system as recited in claim 14, wherein said memory unit is operable for storing a second computer program for retrieving the location of said installed middleware application, wherein said processor, responsive to said second computer program, comprises:
circuitry for decrypting said installation location of said first middleware application with said generated public key obtained from a developer of said first middleware application.

16. The system as recited in claim 15, wherein said processor, responsive to said second computer program, comprises:
circuitry for installing a second application within said first middleware application; and
circuitry for discarding said generated public key.

17. A system, comprising:
a processor; and
a memory unit coupled to said processor, wherein said memory unit is operable for storing a first computer program for protecting the location of containers contained within an installed middleware application;
wherein said processor, responsive to said first computer program, comprises:
circuitry for generating a symmetric key at build time of a middleware application;
circuitry for installing a container;
circuitry for installing said middleware application to store said installed container;
circuitry for encrypting an installation location of said container with said generated symmetric key; and
circuitry for storing said generated symmetric key in a password file.

18. The system as recited in claim 17, wherein said memory unit is operable for storing a second computer program for retrieving the location of said container within said installed middleware application, wherein said processor, responsive to said second computer program, comprises:
circuitry for implementing an algorithm to determine a location of said password file to obtain said generated symmetric key; and
circuitry for decrypting said installation location of said container with said obtained symmetric key.

19. The system as recited in claim 18, wherein said processor, responsive to said second computer program, comprises:
circuitry for discarding said obtained symmetric key.
